(19) United States
(12) Patent Application Publication
(10) Pub. No.: US 2004/0195860 A1
(43) Pub. Date: Oct. 7, 2004

(54) Door-frame for a vehicle door

(76) Inventors: Harald Koellner, Altenstadt (DE); Bernhard Eckhardt, Wetzlar (DE); Enrico Schliwa, Eisenach (DE); Bernhard Sielhorst, Sontra (DE)

Correspondence Address: Marshall & Melhorn, 8th Floor, Four SeaGate, Toledo, OH, 43604, US

(21) Appl. No.: 10/478,600

(22) PCT Filed: May 29, 2002
(86) PCT No.: PCT/EP02/05902

(30) Foreign Application Priority Data
May 29, 2001 (DE) 101 26 250.7

(51) Int. Cl. B60J 5/00

(52) U.S. Cl. 296/146.5

(57) ABSTRACT

The invention relates to a door-frame for a vehicle door, whose lateral parts are configured as die-cast parts. This enables a large number of functional parts of the door to be integrated into the lateral parts and the overall number of door-frame parts to be reduced in comparison with door-frames in prior art.

### BACKGROUND OF THE INVENTION

The invention relates to a door-frame for a vehicle door which comprises first and second die cast lateral parts and at least two struts connecting the lateral parts, wherein a receiver for deflection rollers and a receiver for a window-lifter drive are integrated into the first and second lateral parts.

Vehicle doors, especially for automotive vehicles, which are constructed of a door-frame with an outer covering and an inner lining, are known. The door-frame provides the necessary stability for a vehicle door and carries, in addition to the trim, the functional elements such as the window-lifter for the mobile window-pane, as well as the necessary guide rails, door-lock with actuating handle, door-hinges and, if necessary, the mounting plate for an exterior mirror. The door-frames are usually formed from extruded sections welded to each other which are bent into the necessary shape before being connected. To strengthen the frame and accommodate the functional elements, additional sections, belts or plates must be welded on. The side impact beam which is usual nowadays in vehicle doors is also welded into the frame. A door-frame according to the prior art thus comprises many individual parts which are joined and welded together in a time-consuming and thus also cost-intensive manner. The frame parts are constructed of aluminium or magnesium alloys known to the person skilled in the art.

### SUMMARY OF THE INVENTION

The object of the invention, therefore, is to provide a vehicle door-frame which has a reduced number of individual parts, and thus also a reduced cost for welding the individual parts. The production costs are reduced, and high functional integration is achieved.

The door-frame according to the invention is formed from two lateral parts and at least two struts connecting the two lateral parts. The side impact beam, which is largely standard in vehicle doors nowadays, can be introduced as the third strut at an appropriate place, but is not necessary for the invention per se. Also not absolutely necessary is an upper window-frame part which upwardly terminates the window region and interconnects the upper ends of the window guide rails.

The lateral parts are preferably die-cast parts. Suitable as the material for the lateral parts are light metal alloys known to the person skilled in the art, such as those formed from aluminium or magnesium for example. The die-cast parts offer the possibility of easily realizing the required outer and inner contours according to the vehicle design. The necessary mountings or receivers for the functional elements and the trims are incorporated structurally. The need for additional attachment of plates and belts or the like, which have to be produced separately, as means of securing the functional parts, disappears.

For the connecting struts, preferably extruded sections are used, the material of which is selected to suit the material of the lateral parts.

By comparison with the prior art, depending on the embodiment with or without an upper window-frame part 5, the number of individual frame parts is reduced to 5 or respectively 6, counting in the side impact beam which is not necessary.

### BRIEF DESCRIPTION OF THE DRAWINGS

The invention will now be explained in greater detail with the aid of FIGS. 1 and 2.

FIG. 1 shows a door-frame according to the invention, without functional parts,

FIG. 2 shows the door-frame as in FIG. 1 but with a window in the closed state and the window-lifter mechanism.

### DESCRIPTION OF THE PREFERRED EMBODIMENT

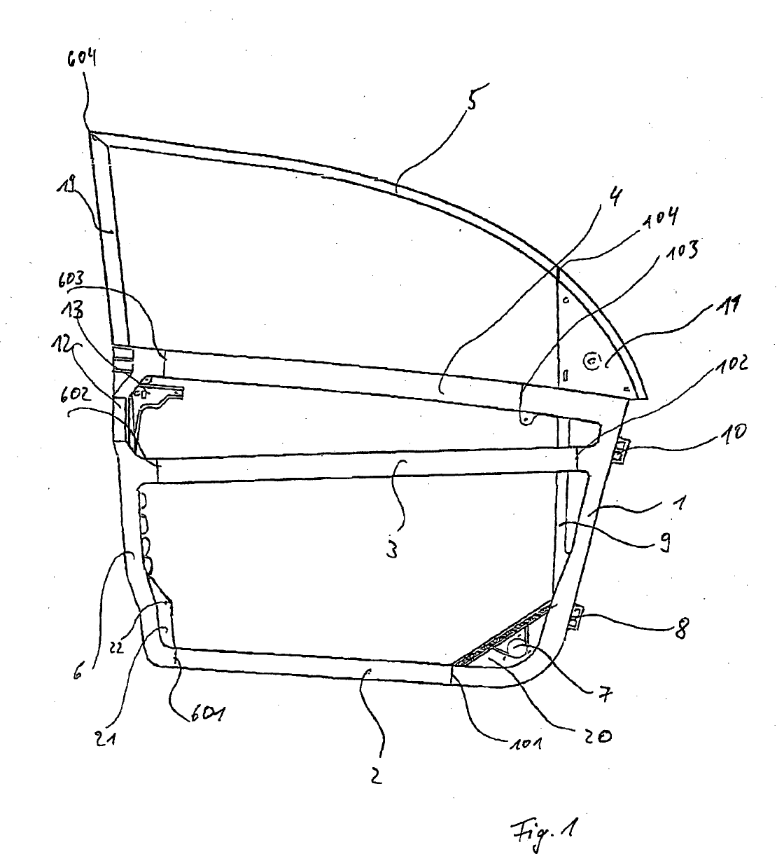

In FIG. 1, 1 designates the first, or right-hand, lateral part of the door-frame, 2 the lower strut, 3 the side impact section, 4 the upper strut, also called the sill, 5 the window-frame part which can be absent on doors with so-called frameless windows, and 6 the second, or left-hand, lateral part. The parts with the reference numerals 2 to 5 are also described in their entirety as transverse members.

First lateral part 1 is connected to the transverse members via the connecting points 101, 102, 103 and 104, second lateral part 6 via the corresponding connecting points 601 to 604. It has proved advantageous so to design the parts at the connecting points 101 to 104, or respectively 601 to 604, so that transverse members and lateral parts are pushed into one another and then welded. This simplifies the assembly of the door-frame. The parts do not have to be fixed separately for welding. Generally, one jig is sufficient for adjusting the required door-frame mass, in which the welding process can also then take place.

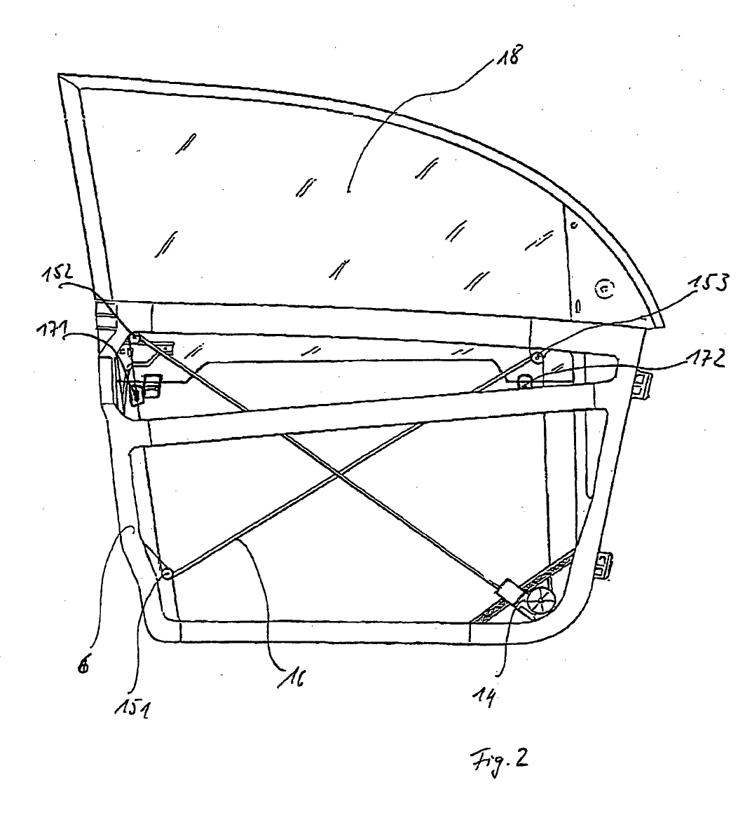

Various functional parts are integrated into first lateral part 1. Reference numeral 9 designates the right-hand window guide rail. The left-hand window guide rail is located in lateral part 6 and is designated by the reference numeral 19. These two guides are integrated as one piece into the corresponding lateral part. The mobile window, reference numeral 18 in FIG. 2, shown in the closed state, can be moved between an open position, in which the upper edge of the window-pane 18 facing window-frame part 5 is located at the height of the sill 4 or only slightly protruding beyond same (not drawn), and a closed position, as is shown in FIG. 2.

Reference numerals 8 and 10 designate two door-hinge parts of the door-frame which are integrated as one piece into lateral part 1. The corresponding counterparts, into which parts 8 and 10 are introduced so as to be mobile in a manner known to the person skilled in the art, are located in the door apertures of the vehicle bodywork (not drawn) and complete the door-hinges.

Reference numeral 11 designates the retaining plate for mounting the exterior mirror. The retaining plate 11 is also an integral constituent part of first lateral part 1.

In second lateral part 6, reference numeral 12 designates a depression into which the door-lock can be introduced and secured. Reference numeral 13 designates the mounting for the door-handle, which mounting is integrated into second lateral part 6 as one piece. Door-lock and door-handle are both not described in greater detail since they are not the subject matter of this invention.

In the lower regions of right-hand lateral part 1 and left-hand lateral part 6, reference numerals 20 and 21 designate reinforcing elements which brace the door-frame against the effect of shearing forces. These parts are also integrated into the lateral parts as one piece.

In first reinforcing element 20, the numeral 7 designates the receiver for a driving motor 14 for the mobile window-pane 18. In second reinforcing element 21 is located the receiver or lug 22 for a deflection roller 151 for the window-lifter mechanism.

The window-lifter mechanism is represented in FIG. 2. This is a cable window-lifter known per se and having a circumferential cable 16 with first, second and third deflection rollers 151, 152 and 153 respectively. First, second and third deflection rollers 151, 152 and 153 are rotatably secured respectively on lugs 22, 23 and 24. These lugs 21, 22 and 23 are again integrated as one piece into first lateral part 1 and second lateral part 6. To this cable are secured mountings 171 and 172 into which the window-pane 18 is inserted. With the aid of the driving motor 14, the cable can be moved in a clockwise or anti-clockwise direction. By this means, the window-pane 18 is moved in the window guides 9 and 19 between an open position and a closed position. FIG. 2 reproduces the closed position of the windowpane 18.

First lateral part 1 and second lateral part 6 are produced as die-cast parts from a light metal alloy. A suitable light metal alloy has proved to be the alloy Magsimal-59 (AlMg5Si2Mn) produced by the company Aluminium Rheinfelden GmbH. Other alloys from the light metal group, such as those based on magnesium for example, are also conceivable.

The transverse members 2 to 5 can be formed as extruded sections from material which is compatible with the alloy of the first lateral part 1 and the second lateral part 6 in respect of electrochemical compatibility (corrosion). These can also be plastics materials with appropriate rigidity and tenacity.

Constructing the first lateral part 1 and the second lateral part 6 as die-cast parts permits high integration of functional elements as described above. This makes possible the small number of individual parts which leads to the advantages by comparison with construction according to prior art.

1. A door-frame for a vehicle door which comprises first and second die cast lateral parts and at least two struts connecting the lateral parts, wherein a receiver for deflection rollers and a receiver for a window-lifter drive are integrated into the first and second lateral parts.

2. The door-frame according to claim 1, wherein guide rails for a mobile window are integrated into the lateral parts.

3. The door-frame according to claim 1, wherein a receiver for a door-lock is integrated into the second lateral part.

4. The door-frame according to claim 1, wherein a mounting for a door-handle is integrated into the second lateral part.

5. The door-frame according to claim 1, wherein door-hinge parts are integrated into the first lateral part.

6. The door-frame according to claim 1, wherein a mounting plate for a rear-view mirror is integrated into the first lateral part.

7. The door-frame according to claim 1, wherein the first and second lateral parts are die-casts from a light metal alloy.

8. The door-frame according to claim 7, wherein the light metal alloy is an aluminium alloy.

9. The door-frame according to claim 7, wherein the light metal alloy is a magnesium alloy.

10. The door-frame according to claim 1, wherein the connecting struts and any additional transverse members comprise extruded sections.

11. The door-frame according to claim 10, wherein the connecting struts and any additional transverse members of comprise a material which is safe in respect of electrochemical compatibility with the material of the lateral parts.
